(19) United States
(12) Patent Application Publication
(10) Pub. No.: US 2001/0029201 A1
(43) Pub. Date: Oct. 11, 2001

(54) Game apparatus, storage medium, transmission medium and computer program

(76) Inventor: Kiyoshi Minami, Tokyo (JP)

Correspondence Address: OLIFF & BERRIDGE, PLC, 277 S. WASHINGTON STREET, SUITE 500, ALEXANDRIA, VA, 22314, US

(21) Appl. No.: 09/817,253

(22) Filed: Mar. 27, 2001

(30) Foreign Application Priority Data
Mar. 29, 2000 (JP) 2000-92485

(51) Int. Cl. A63F 13/00

(52) U.S. Cl. 463/31

(57) ABSTRACT

A game apparatus, a storage medium, a transmission medium and a computer program, which can variously relate a plurality of characters appearing on a game to a plurality of players operating the characters, respectively. The game apparatus for executing a predetermined game wherein groups each of which is composed of a plurality of characters which are controlled by a player or a computer fight with one another, to decide which group wins the predetermined game in accordance with wins or loses of characters of the groups, comprises: a selecting section (51 to 53) for selecting at least one character to be operated by a player, from the characters; and a relating section (212) for relating the player to at least one character selected by the selecting section; wherein a plurality of characters belonging to one of the groups are able to be operated by a plurality of players, respectively.

### BACKGROUND OF THE INVENTION

1. Field of the Invention

This invention relates to a game apparatus, a storage medium, a transmission medium and a computer program, and more particularly, to a game apparatus and so on for relating characters appearing on a game to players operating the characters.

2. Description of Related Art

Various types of game apparatuses by which a plurality of players can enjoy playing one game at the same time, are developed and realized. For example, a game apparatus executing a shooting game wherein two players shoot down foe characters in concert with each other is known as the above-described game apparatus. Further, a game apparatus executing a racing game wherein a plurality of players contend with each another for a rank is known as the above-described game apparatus.

Further, a fighting action game is known as one of the most popular games, recently. The fighting action game is played between two players, wherein they fight with each other by operating the characters assigned thereto. The fighting action game is very popular, in view of a probability of (insight into) techniques given by an opponent character, an agility required in operation, a refreshing feel wherein the player feel when the technique is hit, and so on.

On the other hand, a sport game such as a soccer game and a baseball game, a role-playing game wherein a plurality of characters act in a group or a party, and so on are known as a game wherein one player operates a plurality of characters.

A tag play is known as one of the game play wherein one player operates a plurality of characters, as described above. The tag play is known as one type of game mode wherein a plurality of characters is grouped into a group, the characters are selectively changed at a predetermined timing, and only one character selected from the group, fights on match.

According to the tag play, because the characters having favorite techniques different from one another are grouped into a group, it is possible that various types of games are carried out. Further, because the entire group is beaten when the character on match is beaten, it becomes important to decide the timing and so on, at which the character is changed into another character. As a result, according to the fighting action game and so on, which can carry out the tag play, it is possible that the player enjoy an exciting game having an enjoyment different from a mere fighting action game.

However, according to the tag play as described above, because one player operates a plurality of characters by turns, it has been possible that only two players including the opponent player enjoy playing the game.

Accordingly, if a plurality of characters grouped into one group can be operated by a plurality of players, respectively, it is possible that the players enjoy the tag play having a double interesting. Further, if the game has not only the tag play but also a play which can be carried out by a plurality of players, it may be possible that the player takes part in the game while the game is executed.

### SUMMARY OF THE INVENTION

It is an object of the present invention to provide a game apparatus, a storage medium, a transmission medium and a computer program, which can variously relate a plurality of characters appearing on a game to a plurality of players operating the characters, respectively.

In accordance with the first aspect of the present invention, in a game apparatus for executing a predetermined game wherein groups each of which is composed of a plurality of characters which are controlled by a player or a computer fight with one another, to decide which group wins the predetermined game in accordance with wins or loses of characters of the groups, the game apparatus comprises: a selecting section (for example, selection marks 51 to 53 shown in FIGS. 4A to 4C) for selecting at least one character to be operated by a player, from the characters; and a relating section (for example, a relating unit 212 shown in FIG. 11) for relating the player to at least one character selected by the selecting section; wherein a plurality of characters belonging to one of the groups are able to be operated by a plurality of players, respectively.

In accordance with the second aspect of the present invention, in a storage medium having a computer-executable program recorded thereon, the program comprises: a program code of executing a predetermined game wherein groups each of which is composed of a plurality of characters which are controlled by a player or a computer fight with one another, to decide which group wins the predetermined game in accordance with wins or loses of characters of the groups; a program code of selecting at least one character to be operated by a player, from the characters; and a program code (for example, a relating program 422 shown in FIG. 11) of relating the player to at least one character selected to be operated by the player so that a plurality of characters belonging to one of the groups are able to be operated by a plurality of players, respectively.

In accordance with the third aspect of the present invention, in a transmission medium transmitting a computer-executable program embodied thereon, the program comprises: a program code of executing a predetermined game wherein groups each of which is composed of a plurality of characters which are controlled by a player or a computer fight with one another, to decide which group wins the predetermined game in accordance with wins or loses of characters of the groups; a program code of selecting at least one character to be operated by a player, from the characters; and a program code of relating the player to at least one character selected to be operated by the player so that a plurality of characters belonging to one of the groups are able to be operated by a plurality of players, respectively.

In accordance with the fourth aspect of the present invention, a computer program comprises program code means for performing the steps of: executing a predetermined game wherein groups each of which is composed of a plurality of characters which are controlled by a player or a computer fight with one another, to decide which group wins the predetermined game in accordance with the wins or loses of characters of the groups; selecting at least one character to be operated by a player, from the characters; and relating the player to at least one character selected to be operated by the player.

It should be noted that the player does not mean a user playing the predetermined game and the player generally means some indication of a user, displayed on the executing screen of the predetermined game. That is, the player means a name for identifying a user playing the predetermined game. Therefore, according to the embodiment of the present invention, the player is not any element to specify the present invention.

Further, the character means one appearing in the predetermined game, to be controlled by a player or by a computer. All the characters belonging to one of the groups can be operated by either one of one player, a plurality of players and a computer, not by the combination of some players and a computer.

Further, the transmission medium transmitting the computer-executable program embodied thereon, includes a data signal and a carrier wave.

According to the game apparatus, the storage medium, the transmission medium and the computer program of the first, second, third and fourth aspects of the present invention, because the characters belonging to one of the groups are operated by a plurality of players, respectively, and the predetermined game is a team play for deciding which group wins the predetermined game on the basis of wins or loses of characters, a teamwork is required not only in the game but also for each of users playing the predetermined game. As a result, because a plurality of characters can carry out one predetermined game, it is possible that the player enjoy a more exciting game. Furthermore, because the characters can be related to the players variously, it is possible that the characters are related to the players more variously according to the number of the players.

Preferably, in accordance with the game apparatus of the first aspect of the present invention, the game apparatus further comprises: a permitting section (for example, a participation acceptance unit 214 shown in FIG. 11) for permitting a player applying for a participation in the predetermined game while the predetermined game is executed, to participate in the predetermined game, when a number of players present participating in the predetermined game is less than a maximum number of players allowable to participate in the predetermined game.

Preferably, in accordance with the storage medium having a computer-executable program recorded thereon, of the second aspect of the present invention, the program further comprises: a program code (for example, a participation permit decision program 424 shown in FIG. 11) of permitting a player applying for a participation in the predetermined game while the predetermined game is executed, to participate in the predetermined game, when a number of players present participating in the predetermined game is less than a maximum number of players allowable to participate in the predetermined game.

Preferably, in accordance with the computer program of the fourth aspect of the present invention, the computer program further comprises program code means for performing the step of: permitting a player applying for a participation in the predetermined game while the predetermined game is executed, to participate in the predetermined game, when a number of players present participating in the predetermined game is less than a maximum number of players allowable to participate in the predetermined game.

The number of players allowable to participate in the predetermined game is a number of player who can be permitted to participate in the predetermined game. The number of players may be fixed or changeable within a range based on a game processing.

According to the game apparatus, the storage medium and the computer program as described above, when the number of the players present participating in the game is less than the maximum number of players allowable to participate in the game, more player can participate in the predetermined game while the predetermined game is executed. As a result, it is convenient for the player applying for the participation in the game while the game is executed. Further, it is possible to realize an intrusion mode in the arcade game machine for playing a fighting action game.

Preferably, in accordance with the game apparatus of the first aspect of the present invention, the game apparatus further comprises: a permitting section for permitting a player applying for a participation in the predetermined game while the predetermined game is executed, to participate in the predetermined game, when a plurality of characters are related to one of the players, wherein the relating section relates the player permitted for the participation in the predetermined game by the permitting section, to a part of the plurality of characters.

Preferably, in accordance with the storage medium having a computer-executable program recorded thereon, of the second aspect of the present invention, the program further comprises: a program code of permitting a player applying for a participation in the predetermined game while the predetermined game is executed, to participate in the predetermined game, when a plurality of characters are related to one of the players; and a program code of relating the player permitted for the participation in the predetermined game to a part of the plurality of characters.

Preferably, in accordance with the computer program of the fourth aspect of the present invention, the computer program further comprises program code means for performing the steps of: permitting a player applying for a participation in the predetermined game while the predetermined game is executed, to participate in the predetermined game, when a plurality of characters are related to one of the players; and relating the player permitted for the participation in the predetermined game to a part of the plurality of characters.

According to the game apparatus, the storage medium and the computer program as described above, because a part of characters operated by one of the players can be related to the new player, it is possible to permit the new player to participate in the game after the relationship between the players and the characters has been completed.

Preferably, in accordance with the game apparatus of the first aspect of the present invention, the game apparatus further comprises: an adding section for adding a new character to one of the groups each of which is composed of a plurality of characters, when a player applies for a participation in the predetermined game while the predetermined game is executed, wherein the relating section relates the player applying for the participation in the predetermined game to the new character added by the adding section.

Preferably, in accordance with the storage medium having a computer-executable program recorded thereon, of the second aspect of the present invention, the program further comprises: a program code of adding a new character to one of the groups each of which is composed of a plurality of characters, when a player applies for a participation in the predetermined game while the predetermined game is executed; and a program code of relating the player applying for the participation in the predetermined game to the new character.

Preferably, in accordance with the computer program of the fourth aspect of the present invention, the computer program further comprises program code means for performing the steps of: adding a new character to one of the groups, when a player applies for a participation in the predetermined game while the predetermined game is executed; and relating the player applying for the participation in the predetermined game to the new character.

According to the game apparatus, the storage medium and the computer program as described above, because the new character can be added in the group all the characters of which have been related to the players, respectively, it is possible to double the interest of the game as a team play.

Preferably, in accordance with the game apparatus of the first aspect of the present invention, the predetermined game is a fighting action game in which the character belonging to one of the groups is changed to another character belonging to the group at a predetermined time, to fight with the character belonging to one another of the groups.

Preferably, in accordance with the game apparatus of the first aspect of the present invention, the predetermined game is a team game in which the characters belonging to one of the groups fight with the characters belonging to one another of the groups, respectively, in order.

According to the game apparatus as described above, because it is possible to increase variations of the team game, it is possible to enjoy the various types of games. Herein, the team game may be a fight wherein the opponent characters are fixed as shown in FIG. 18A, or a tournament as shown in FIG. 18B.

In accordance with the fifth aspect of the present invention, a game apparatus comprises: a selecting section for selecting a plurality of characters belonging to a group, to be operated by a first player; a relating section for relating a second player to a part of the characters selected by the selecting section, to be operated by the first player, when a number of the characters selected by the selecting section is equal to a number of all the characters belonging to the group; and a executing section for executing a predetermined game according to a relationship between the characters and the first and second players, related by the relating section.

In accordance with the sixth aspect of the present invention, in a storage medium having a computer-executable program recorded thereon, the program comprises: a program code of selecting a plurality of characters belonging to a group, to be operated by a first player; a program code of relating a second player to a part of the characters selected to be operated by the first player, when a number of the characters selected to be operated by the first player is equal to a number of all the characters belonging to the group; and a program code of executing a predetermined game by displaying a game image according to a relationship between the characters and the first and second players.

According to the game apparatus and the storage medium of the fifth and sixth aspects of the present invention, because a part of a plurality of characters operated by the first player can be related to the second player, it is possible that the second player participates in the game while the first player is playing the game, as a partner of the first player.

Further, in the case wherein the second player stops playing the game while the first and second players are playing the game, the character related to the second player may be related to the first player. It is preferable that the case is applied to a roll-playing game and so on, in which the characters take action in a group, that is, a party and it takes a long time from a start to end of the game.

In accordance with the seventh aspect of the present invention, in a transmission medium transmitting a computer-executable program embodied thereon, between a host apparatus and a plurality of game terminals in a game system, the program comprises: a program code of executing a predetermined game wherein groups each of which is composed of a plurality of characters which are controlled by a player or a computer fight with one another, to decide which group wins the predetermined game in accordance with wins or loses of characters of the groups, in the game system; and a program code of relating the game terminal to at least one character so that a plurality of characters belonging to one of the groups are able to be operated by a plurality of game apparatuses, respectively.

According to the transmission medium of the seventh aspect of the present invention, in a game over a network communication system which requires a team work, because the terminals can be variously related to characters of the group, it is unnecessary that the terminal fights with a predetermined opponent player or plays the game with a predetermined player. Accordingly, it is possible to broaden how to play the game such as the player is related to a strange player, that is, a strange user or a strange terminal.

Preferably, in accordance with the transmission medium transmitting a computer-executable program embodied thereon, of the seventh aspect of the present invention, the program further comprises: a program code of permitting the game apparatus applying for a participation in the predetermined game while the predetermined game is executed, to participate in the predetermined game, when a number of players present participating in the predetermined game is less than a maximum number of players allowable to participate in the predetermined game.

Preferably, in accordance with the transmission medium transmitting a computer-executable program embodied thereon, of the seventh aspect of the present invention, the program further comprises: a program code of permitting the game apparatus applying for a participation in the predetermined game while the predetermined game is executed, to participate in the predetermined game, when a plurality of characters are related to one of the game apparatuses; and a program code of relating the game apparatus permitted for the participation in the predetermined game to a part of the plurality of characters.

Preferably, in accordance with the transmission medium transmitting a computer-executable program embodied thereon, of the seventh aspect of the present invention, the program further comprises: a program code of adding a new character to one of the groups each of which is composed of a plurality of characters, when the game apparatus applies for a participation in the predetermined game while the predetermined game is executed; and a program code of relating the game apparatus applying for the participation in the predetermined game to the new character.

According to the transmission medium as described above, because the game terminal can participate in the game while the game is executed at any time, it is convenient for the game terminal applying for the participation in the game while the game is executed. Further, because the new game terminal participate in the game as an adventitious player, it is possible that the game players (terminals) playing the game enjoy the game more.

In accordance with the eighth aspect of the present invention, a game apparatus comprises; an executing section for executing a predetermined game wherein groups each of which is composed of a plurality of characters fight with one another, to decide which group wins the predetermined game in accordance with wins or loses of the characters of the groups; an operating section for selecting at least one character from the characters to operate at least one character selected thereby; and a relating section for relating the operating section to at least one character selected by the operating section.

### BRIEF DESCRIPTION OF THE DRAWINGS

The present invention will become more fully understood from the detailed description given hereinafter and the accompanying drawings which are given by way of illustration only, and thus are not intended as a definition of the limits of the present invention, and wherein:

FIG. 1 is a perspective view of an exemplary case wherein the game apparatus of the present invention is applied to a consumer game machine;

FIG. 2 is a view showing a conception of a tag play in a fighting action game;

FIG. 3 is a view showing an exemplary screen of accepting a participation in a fighting game, before the fighting play;

FIGS. 4A to 4C are views showing an exemplary screen of accepting a participation in a fighting game, before the fighting play;

FIGS. 5A to 5C are views showing an exemplary screen of accepting a participation in a fighting game, before the fighting play;

FIGS. 6A and 6B are views showing an exemplary screen of accepting a participation in a fighting game, before the fighting play;

FIGS. 7A to 7C are views showing an exemplary screen of accepting a participation in a fighting game, before the fighting play;

FIGS. 8A and 8B are views showing an exemplary screen of accepting a participation in a fighting game, before the fighting play;

FIGS. 9A and 9B are views for explaining a processing of accepting a participation in a fighting game during the fighting play;

FIGS. 10A and 10B are views for explaining a processing of accepting a participation in a fighting game during the fighting play;

FIG. 11 is a functional block diagram according to a preferred embodiment of the game apparatus of present invention;

FIG. 12A is a diagram showing an example of a relating data 252; FIG. 12B is a diagram showing an example of a permit condition data 254;

FIG. 13 is a flow chart showing a process of a processing of accepting a participation in a game;

FIGS. 14A and 14B are flow charts showing a process of a processing of deciding a permit for a participation in a game;

FIG. 15 is a block diagram showing an example of a hardware configuration realizable the game apparatus according to the embodiment of the present invention;

FIGS. 16A to 16C are views showing examples of various embodiments of the game apparatus of the present invention;

FIG. 17 is a view for explaining that the characters can be selected to be operated by a player, as a modified example of the embodiment of the game apparatus of the present invention; and

FIGS. 18A and 18B are views for explaining the number of characters and how to fight, as a modified example of the embodiment of the game apparatus of the present invention.

### PREFERRED EMBODIMENT OF THE INVENTION

Hereinafter, a preferred embodiment of the present invention will be explained with reference to figures, as follows. Although the case wherein the present invention is applied to a tag play in a fighting action game will be mainly explained as follows, it is not limited to the tag play to which the present invention is applied.

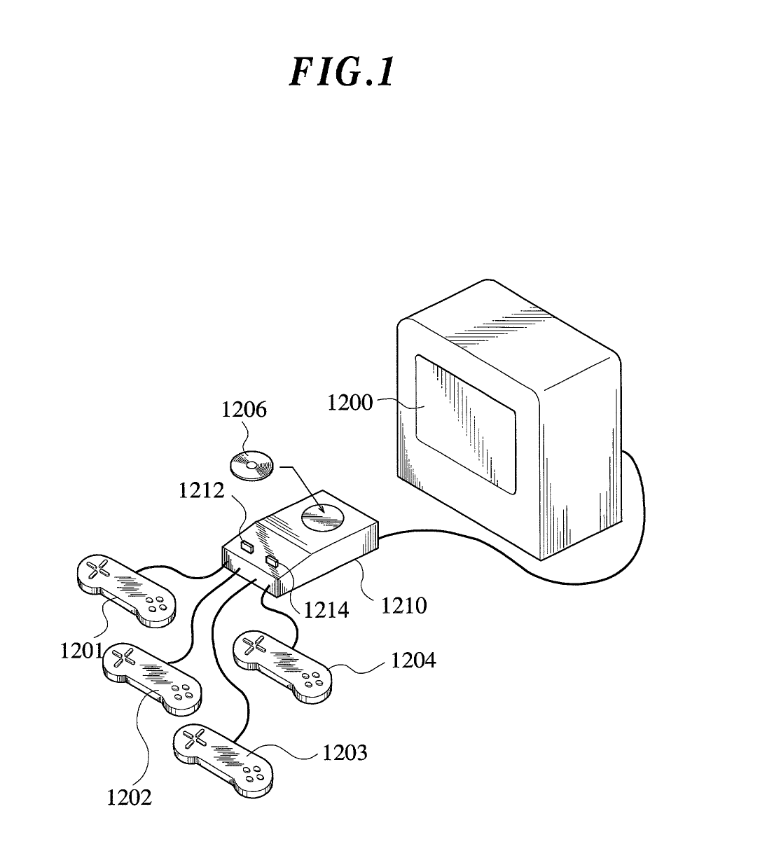

FIG. 1 is a view showing one example of the case wherein the game apparatus of the present invention is applied to a consumer game machine.

Hereinafter, the players playing with the game apparatus will be explained as a maximum of four players designated as players 1P to 4P.

In FIG. 1, the players operate game controllers 1201, 1202, 1203 and 1204, respectively, as watching a game image displayed on a display 1200, of the game, to enjoy playing the game such as a fighting action game or the like. In the case as described above, a necessary data such as a game program and so on, to play the game is stored in an data storage media detachable from and attachable to an apparatus body 1210, for example, a CD-ROM 1206, an IC card 1212, a memory card 1214 and so on.

It should be noted that the player does not mean a person that is a user playing the game and the player generally means some indication of a user, displayed on the executing screen of the game. That is, the player means a name for identifying a user playing the game from other user, throughout the specification.

A method realizable of discriminating among the players will be explained, as follows. One player certainly uses one game controller (input operating unit). Therefore, the game apparatus side treats one player and one game controller (input operating unit) as one. More particularly, the game apparatus side discriminates the game controller (input operating unit) as the player, thereby the game apparatus side discriminates the players individually. Accordingly, when the player uses another game controller different from the game controller related to the player, the game apparatus discriminates the player in error.

As described above, the player used throughout the specification, means a player discriminated by the game apparatus side.

In FIG. 1, according to the game apparatus, four game controllers 1201, 1202, 1203 and 1204 are connected to the apparatus body 1210. However, the number of game controllers connected to the apparatus body 1210 may be modified according to the number of the players. Further, one player may enjoy playing the fighting action game in the state wherein four game controllers are connected to the apparatus body 1210.

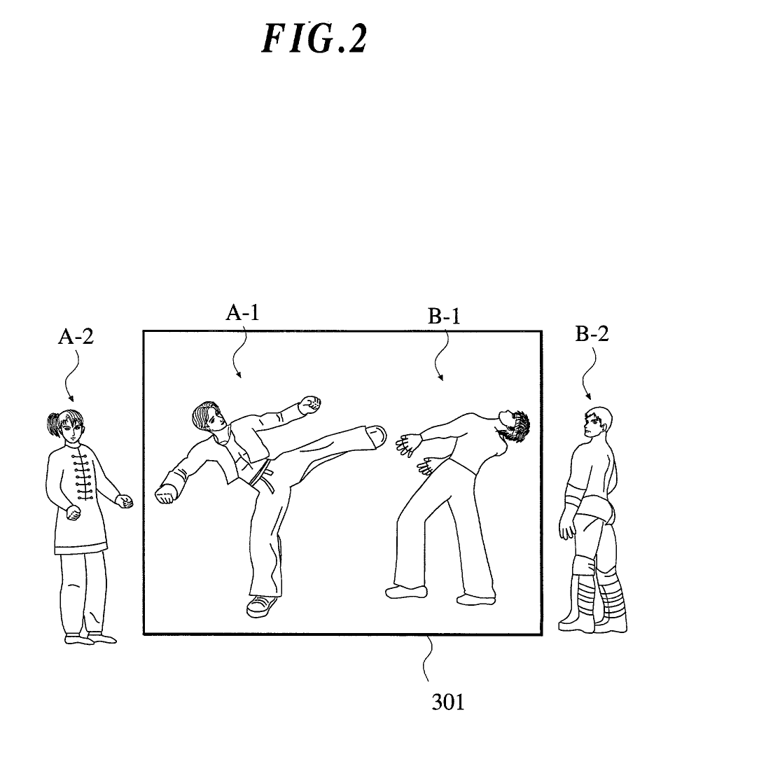

FIG. 2 is a view showing the conception of the tag play in the fighting action game.

As shown in FIG. 2, a character A-1 fights with a character B-1 on a screen 301. The character A-1 is grouped into a group A to which a character A-2 belongs. The character B-1 is grouped into a group B to which a character B-2 belongs.

When the game apparatus receives a predetermined input operation by the game controller, the character is changed to another character belonging to the same group. Thereafter, another character continues fighting. When any one of characters fighting on the screen 301 is beaten, more particular, when the life of any one of characters fighting is equal to zero, the defeat of the group to which the character beaten belongs is determined.

Therefore, a timing of changing the characters concerns a win or a loss in the case wherein the characters which are not congenial fights with each other, in the case wherein the characters which have the different decreases of lives from each other fights with each other, or the like. Accordingly, in the case wherein the first and second players operates the first and second characters belonging to the same group, respectively, it is required that the players carry out a change operation and so on, with getting on well with each other. As a result, it is possible that the players more enjoy the game.

Hereinafter, the processing of relating the player to the character and the processing of participating in the play of the game will be explained in detail, with reference to drawings, before the fighting play and during the fighting play.

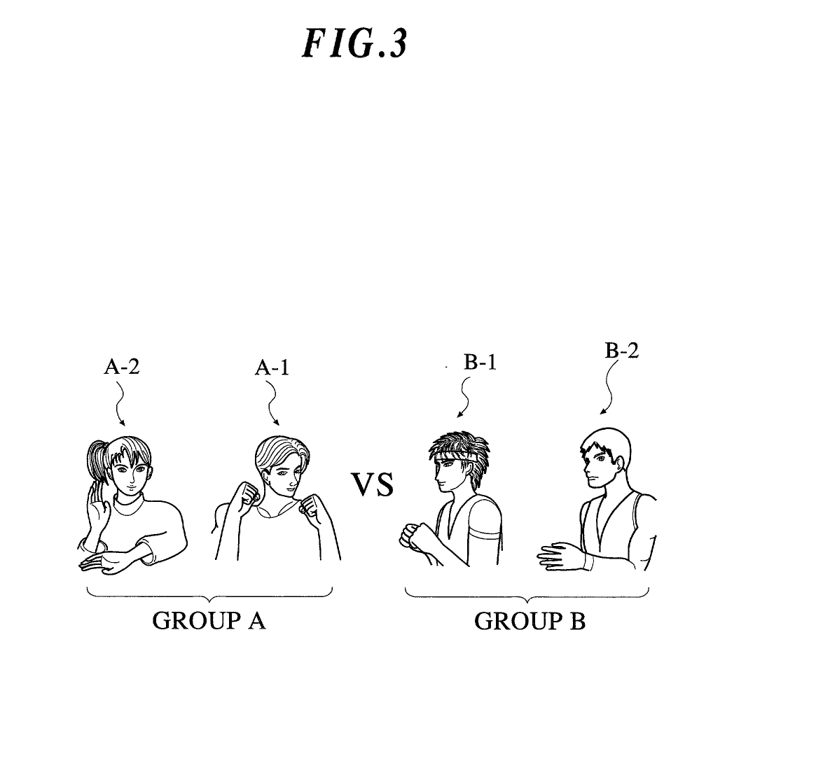

FIGS. 3 to 8B are views showing exemplary screens of accepting the participation in the game before the fighting play.

In FIG. 3, the player desiring to participate in the game applies for the participation by operating a predetermined operating button. According to the embodiment of the present invention, each group of the tag play is composed of two characters. More particularly, the group A is composed of the characters A-1 and A-2, and the group B is composed of the characters B-1 and B-2.

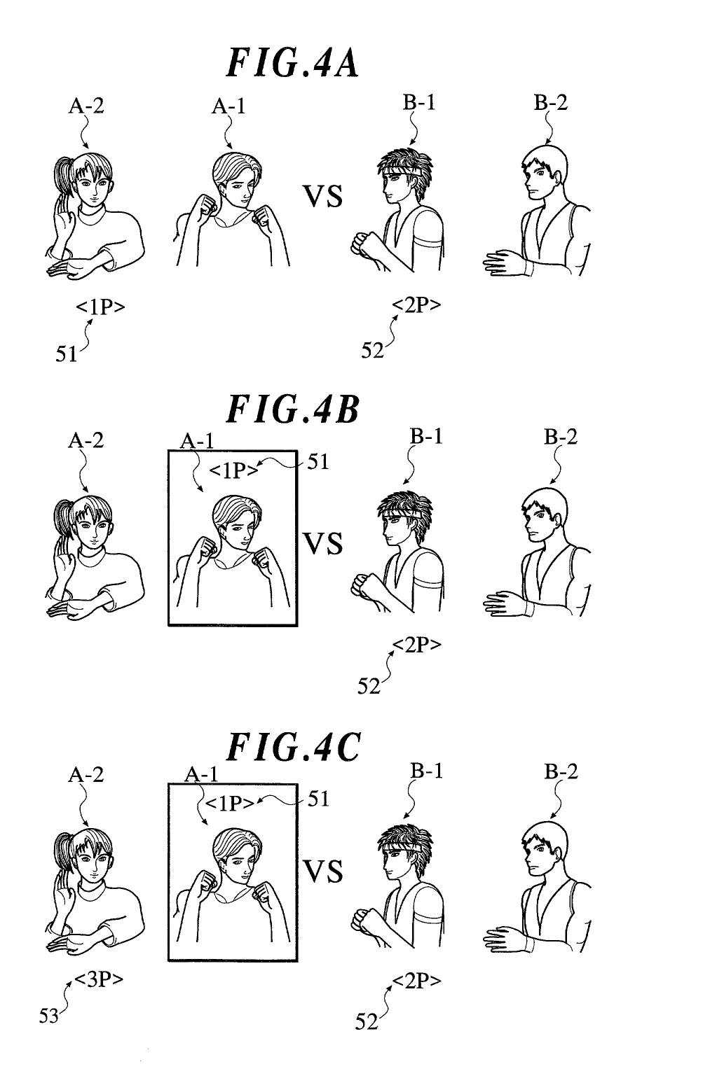

FIG. 4A is a view showing an example of a screen in the state wherein two players have applied for the participation in the game.

In FIG. 4A, a selection mark 51 of the player 1P and a selection mark 52 of the player 2P are displayed on the screen. When the player 1P operates the own game controller to shift the selection mark 51 to a position of the desired character, the player 1P can determine the character as an object of operating. Further, the player 2P can determine the character as an object of operating like the case of the player 1P.

FIG. 4B is a view showing an example of a screen in the state wherein the character A-1 has been determined as the character of the player IP in the screen shown in FIG. 4A.

Because the character of the player 2P has not determined, it is possible that the player 2P selects any one of characters other than the character A-1.

FIG. 4C is a view showing an example of screen in the state wherein a player 3P has participated in the game in the screen shown in FIG. 4B.

Because the number of players participating in the game is equal to two in the state shown in FIG. 4B, the player 3P are permitted to participate in the game. Because the character A-1 has been determined by the player 1P, it is possible that each of players 2P and 3P selects any one of characters other than the character A-1, respectively.

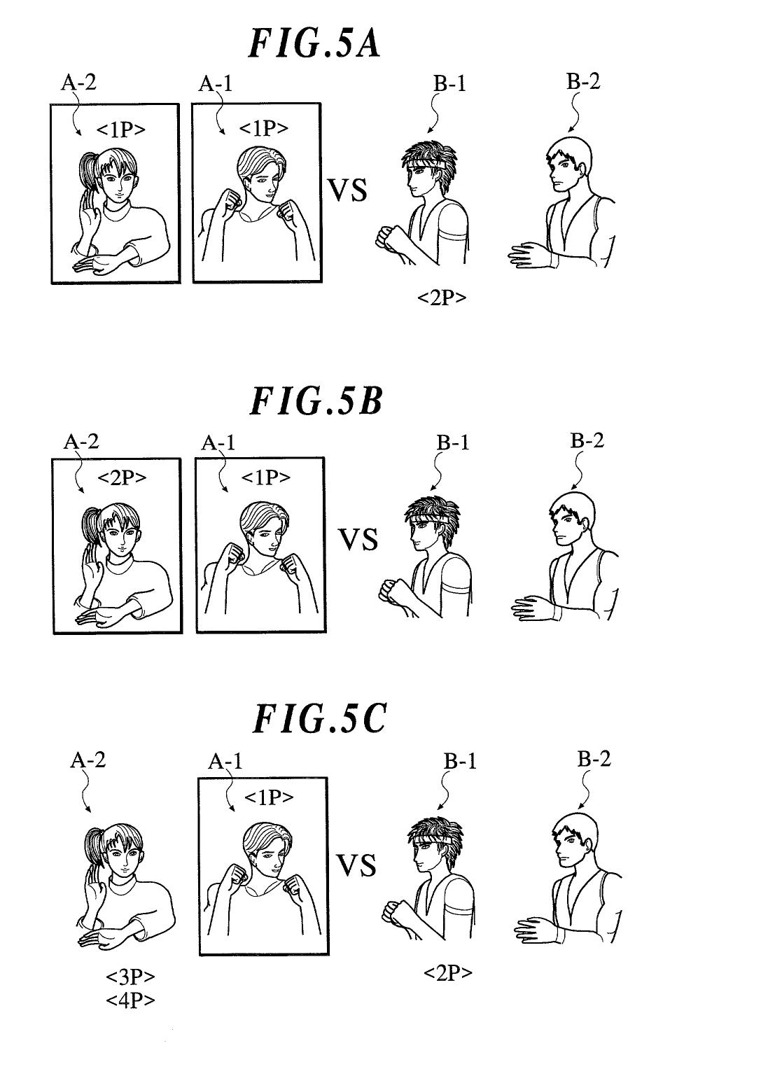

FIG. 5A is a view showing an example of a screen in the state wherein the player 1P again has participated in the game in the screen shown in FIG. 4B.

Because the character A-1 has already determined as the character of the player 1P, the character A-2 remained in the group A is related to the player 1P, automatically.

If the character A-2 has been related to another player as shown in FIG. 5B or four players have already participated in the game as shown in FIG. 5C, the player 1P is rejected to participate in the game.

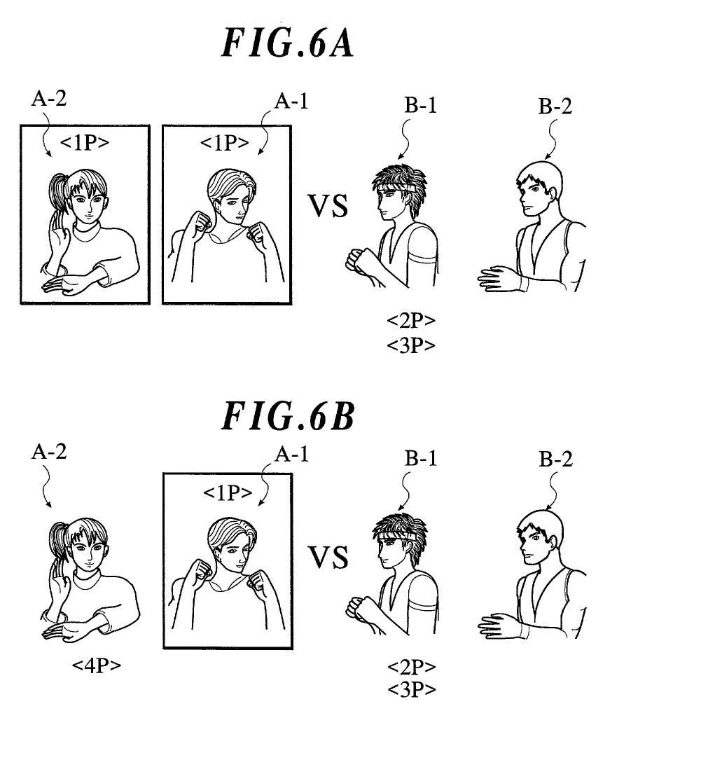

FIG. 6A is a view showing an example of a screen in the state wherein the characters A-1 and A-2 have been related to the player 1P and the characters of the players 2P and 3P are not determined.

In the case as described above, the player 4P may be permitted to participate in the game or not be permitted to participate in the game. According to the embodiment of the present invention, it will be explained that the player 4P is permitted to participate in the game.

That is, in the case as described above, as shown in FIG. 6B, any one of the characters A-1 and A-2 related to the player 1P is released, in order to permit the player 4P to participate in the game. Various methods of releasing any one of the characters related to the player are known, for example, the method of releasing the character in order from the character related to the player at the last, the method of releasing the character in predetermined order, and so on, are known. Any method of releasing the character may be applied to the embodiment of the present invention.

The fighting play automatically is started when all of four characters are related to the players, respectively.

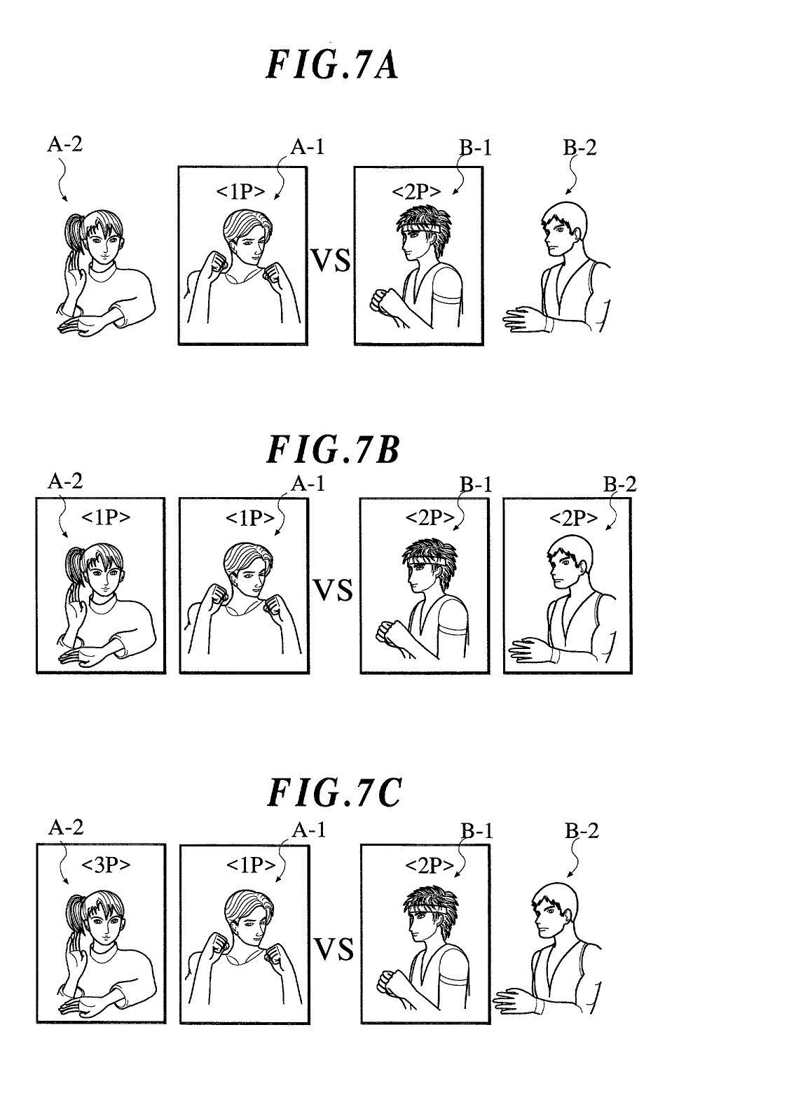

As shown in FIG. 7A, in the case wherein the characters A-1 and B-1 have been related to the players 1P and 2P, respectively, and the characters A-2 and B-2 are not related to any player, the characters A-2 and B-2 will be related to any player, as follows.

That is, the fighting play is not started until any player does not instruct the game apparatus to start the fighting play. When any player instructs the game apparatus to start the fighting game in the screen shown in FIG. 7A, the characters A-2 and B-2 are compulsively related to the player 1P and the player 2P, respectively, as shown in FIG. 7B. As a result, it is determined that the groups A and B are operated by the player 1P and the player 2P, respectively.

As shown in FIG. 7C, in the case wherein one character, that is, the character B-2 is not related to any player, the processing is carried out like the processing as shown in FIG. 7B.

In other words, because the character B-2 belongs to the group B composed of the characters B-1 and B-2, the character B-2 is related to the player 2P to which the character B-1 is related.

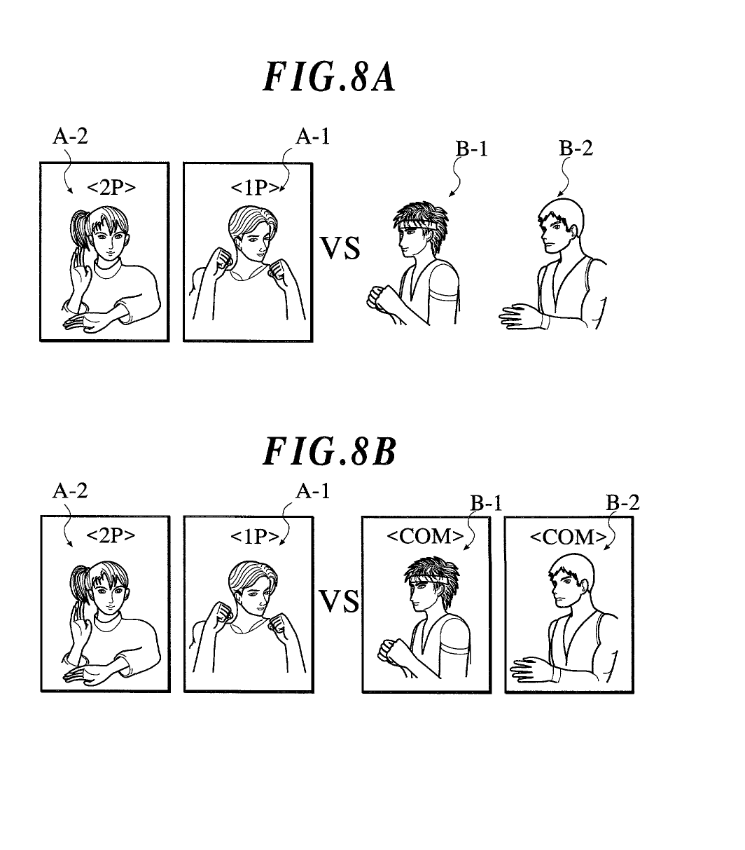

As shown in FIG. 8A, in the case wherein the characters A-1 and A-2 of the group A have been related to the players 1P and 2P, respectively, all the characters of the group B are not related to any player, and any player dose not participate in the game, when any player instructs the game apparatus to start the fighting game, the characters B-1 and B-2 of the group B are controlled by a computer of the game apparatus, as shown in FIG. 8B.

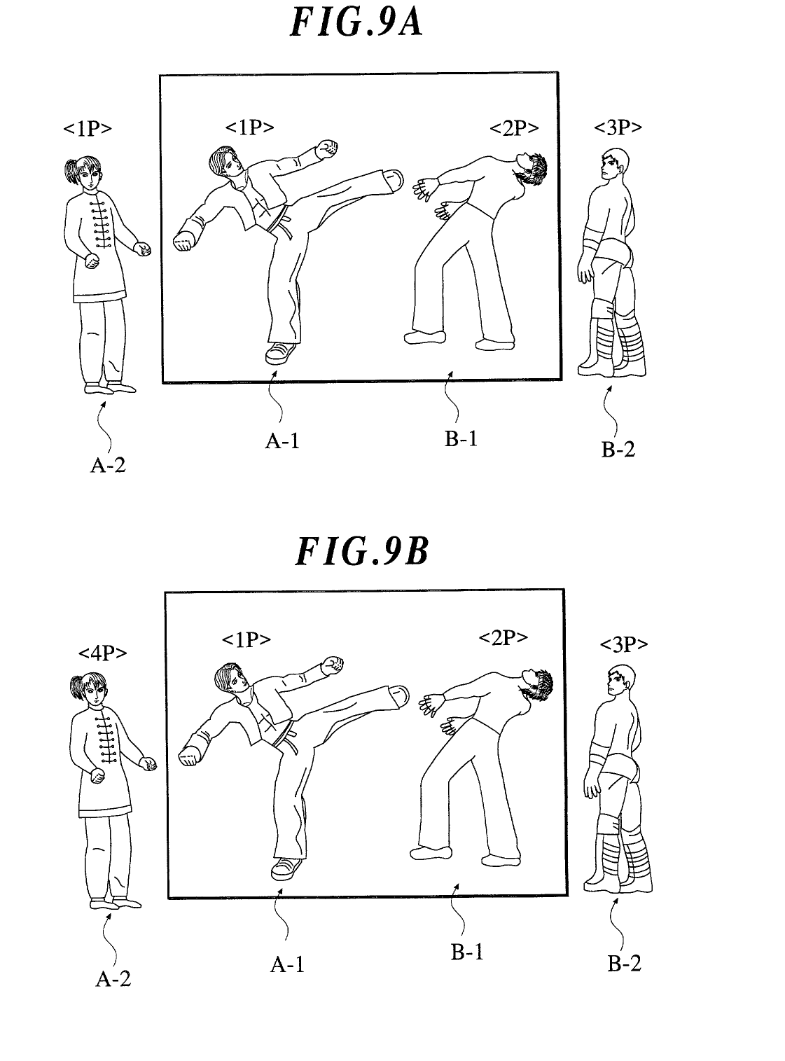

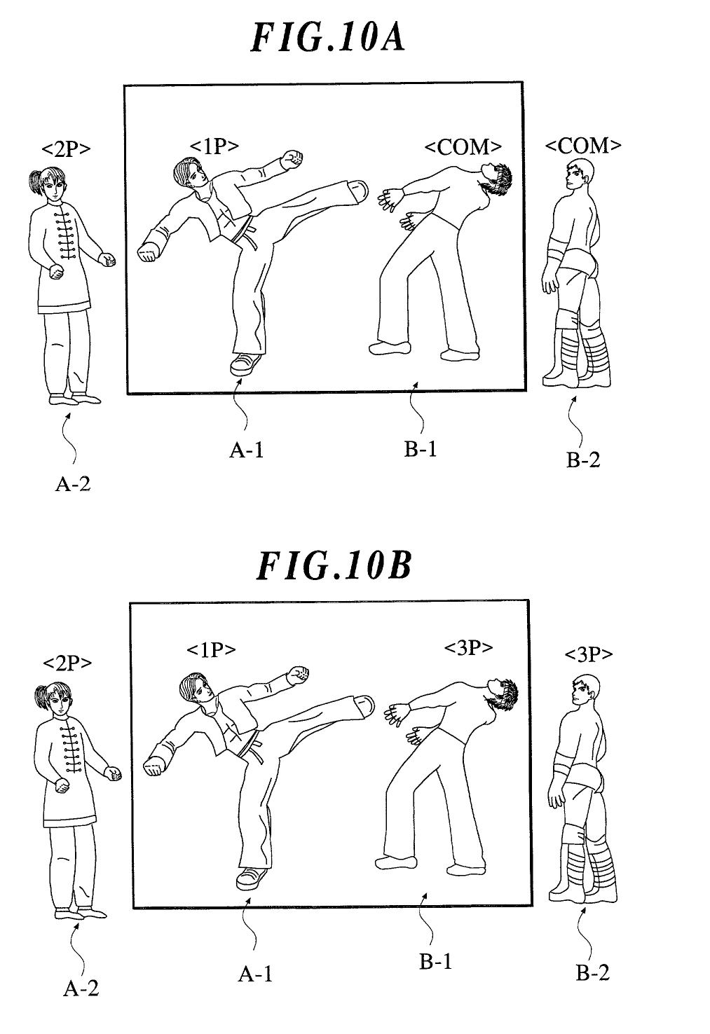

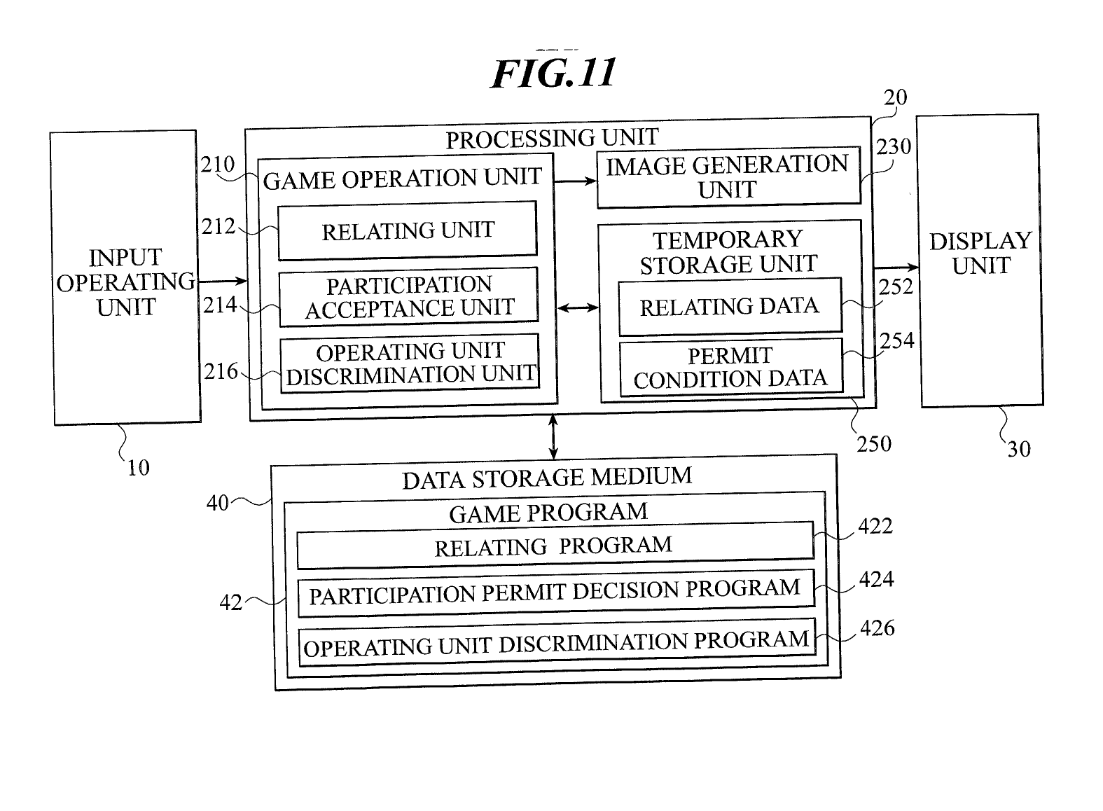

FIGS. 9A to 10B are views for explaining a processing of accepting the participation in the fighting game during the fighting play.

FIG. 9A is a view showing a conception of the tag play when the player 1P operates the characters A-1 and A-2 of the group A, and the players 2P and 3P operate the characters B-1 and B-2 of the group B, respectively.

In the state as shown in FIG. 9A, when the player 4P applies for the participation in the game by operating a predetermined input operating unit, the player 4P is permitted to participate in the game, like the case before the fighting play described with reference to FIGS. 6A and 6B. Therefore, the player 4P can operate one character, that is, the character A-2 of the group A as shown in FIG. 9B.

As shown in FIG. 10A, in the case wherein the characters B-1 and B-2 of the group B are controlled by the computer, when a new player, that is, the player 3P applies for the participation in the game, the player 3P is permitted to participate in the game. Therefore, the characters B-1 and B-2 of the group B controlled by the computer are related to the player 3P.

As described with references to FIGS. 9A to 10B, when the player applies for the participation in the game during the fighting play, the game play may be interrupted temporarily by displaying the screen of accepting the participation in the game, or may be returned to the state before the fighting play as shown in FIG. 3 or the like.

FIG. 11 is a functional block diagram of the game apparatus according to the embodiment of the game apparatus of the present invention. As shown in FIG. 11, the game apparatus comprises an input operating unit 10, a processing unit 20, a display unit 30, and a data storage medium 40.

The input operating unit 10 is used for the player to input an operation data. The input operating unit 10 has a function realized by hardware having a lever, buttons and so on. When either one of the buttons or the like is pushed down, the input operating unit 10 outputs an operation signal to the processing unit 20. The input operating unit 10 relates to the game controllers 1201 to 1204 as shown in FIG. 1.

The processing unit 20 carries out a processing of positioning objects including characters in an object space, a processing of controlling movements of characters under the control of a computer, a processing of generating images to be viewed from a predetermined viewpoint in the object space, and so on, on the basis of the above-described operation signal, a game program 42 stored in the data storage medium 40, for executing the fighting action game, and so on. The processing unit 20 has a function realized by hardware such as a CPU, for example, a CISC type of CPU or a RISC type of CPU, a DSP, an ASIC, for example, a gate array or the like, a memory, for example, a ROM, a RAM or the like, and so on.

The processing unit 20 comprises a game operation unit 210, an image generation unit 230, and a temporary storage unit 250.

The game operation unit 210 carries out a processing of progressing the game, a processing of deciding the position of the viewpoint and the direction of the line of sight, a processing of controlling the movements of characters, a processing of setting the object space, and so on. Further, the game operation unit 210 comprises a relating unit 212, a participation acceptance unit 214, an operating unit discrimination unit 216.

The relating unit 212 relates the players to the characters. The participation acceptance unit 214 decides whether or not the participation in the game is permitted before and while the game is executed. The operating unit discrimination unit 216 decides whether or not the input operating unit 10 is connected to the processing unit 20.

The image generation unit 230 carries out a processing of generating images at a predetermined viewpoint in the object space set by the game operation unit 210. The image generated by the image generation unit 230 is displayed on the display unit 30.

The temporary storage unit 250 stores a relating data 252 and a permit condition data 254, therein.

The relating data 252 stores the relationship between the players and the characters related by the relating unit 212, therein. The permit condition data 254 stores the condition when the participation acceptance unit 214 decides whether permitting a player to participate in the game or not.

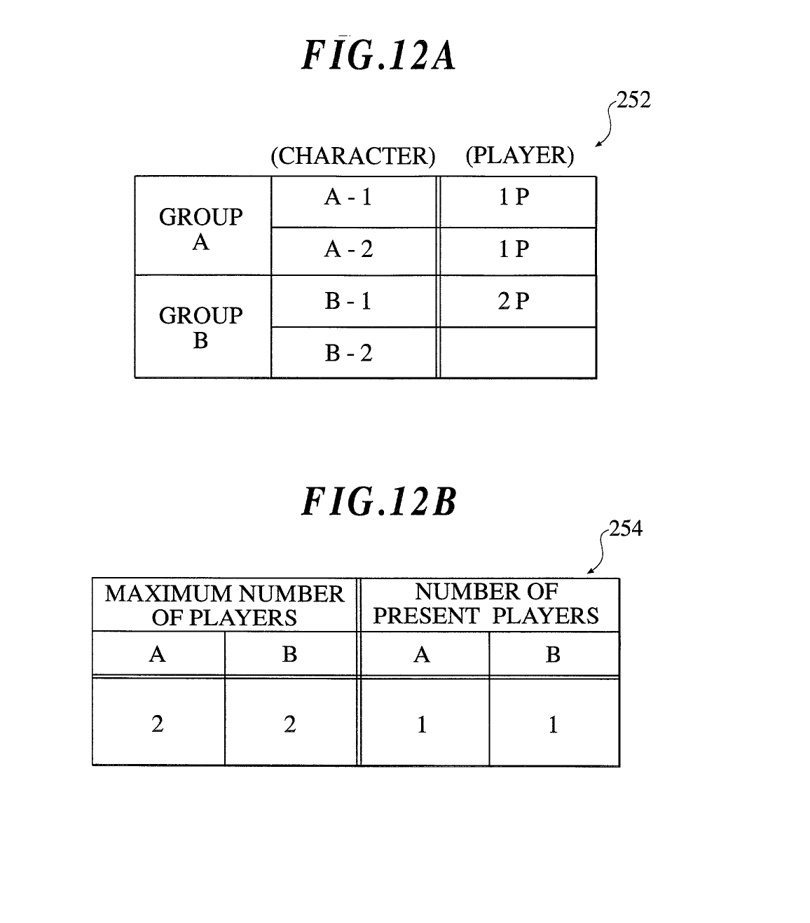

FIG. 12A is a diagram showing an example of the relating data 252.

In FIG. 12A, the characters A-1 and A-2 are related to the player 1P. The character B-1 is related to the player 2P. The character B-2 is not related to any player.

FIG. 12B is a diagram showing an example of the permit condition data 254 in the state shown in FIG. 12A.

In FIG. 12B, as the maximum number of players allowable to participate in the game, “2” is set in the group A, and “2” is set in the group B. As the number of players present participating in the game, “1” is stored in the group A, and “1” is stored in the group B.

Accordingly, in the state as shown in FIGS. 12A and 12B, it is possible that one more player participates in the group B. More particularly, the player 3P or 4P can participate in the group B.

Further, as described above with reference to FIGS. 6A and 6B, it is possible that one more player participates in the group A.

The data storage medium 40 stores not only the game program 42 on the fighting action game but also a relating program 422, a participation permit decision program 424, an operating unit discrimination program 426, and so on.

The relating program 422 is read out and executed by the relating unit 212. The participation permit decision program 424 is read out and executed by the participation acceptance unit 214. The operating unit discrimination program 426 is read out and executed by the operating unit discrimination unit 216.

Although the relating program 422, the participation permit decision program 424 and the operating unit discrimination program 426 are shown in figures so as to be stored in the game program 42, as subroutines of the game program 42, they may be separated from the game program 42.

Further, the data storage medium 40 stores data on objects including characters, a source of light, the viewpoint, and so on. The data storage medium 40 has a function realized by hardware such as a CD-ROM, a game cassette, an IC card, a MO, a FD, a DVD, a hard disk, a memory and so on. The processing unit 20 reads the data and the programs out of the data storage medium 40 to execute various types of processing on the basis of them.

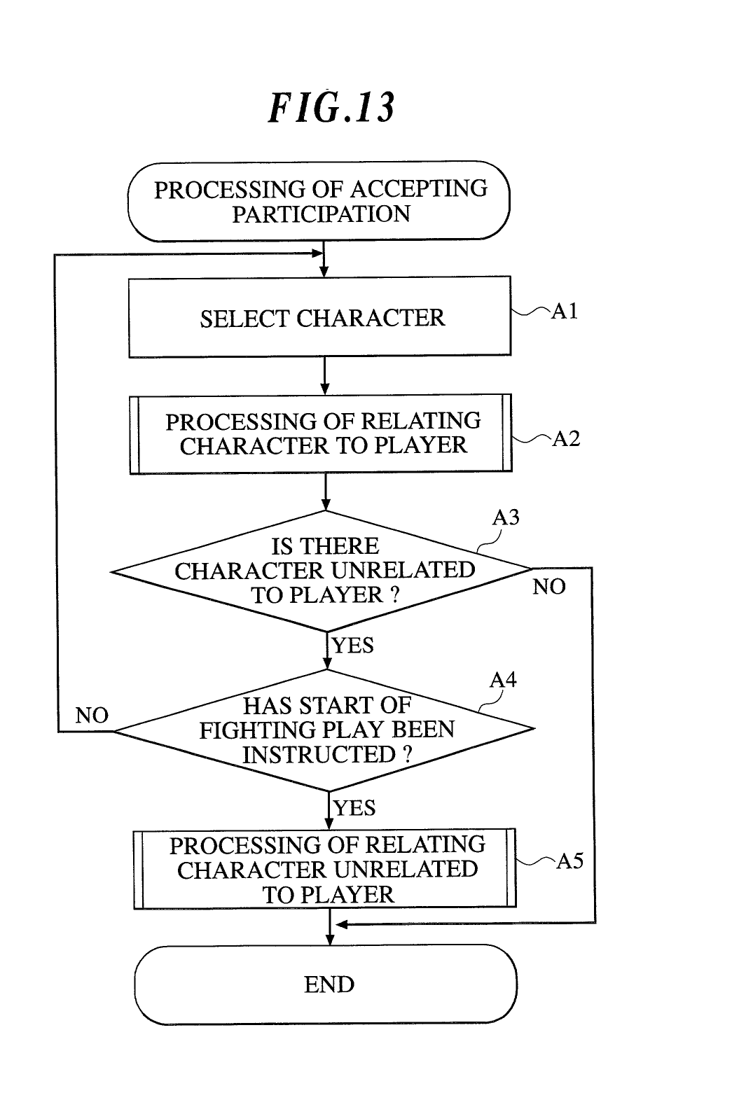

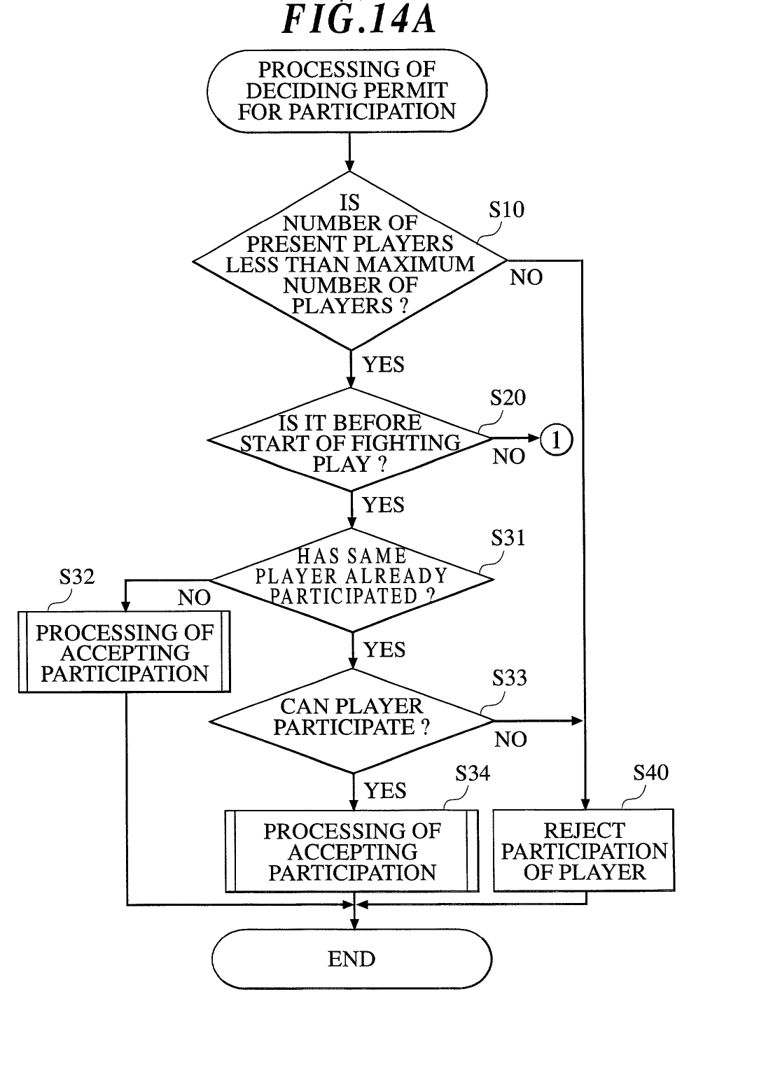

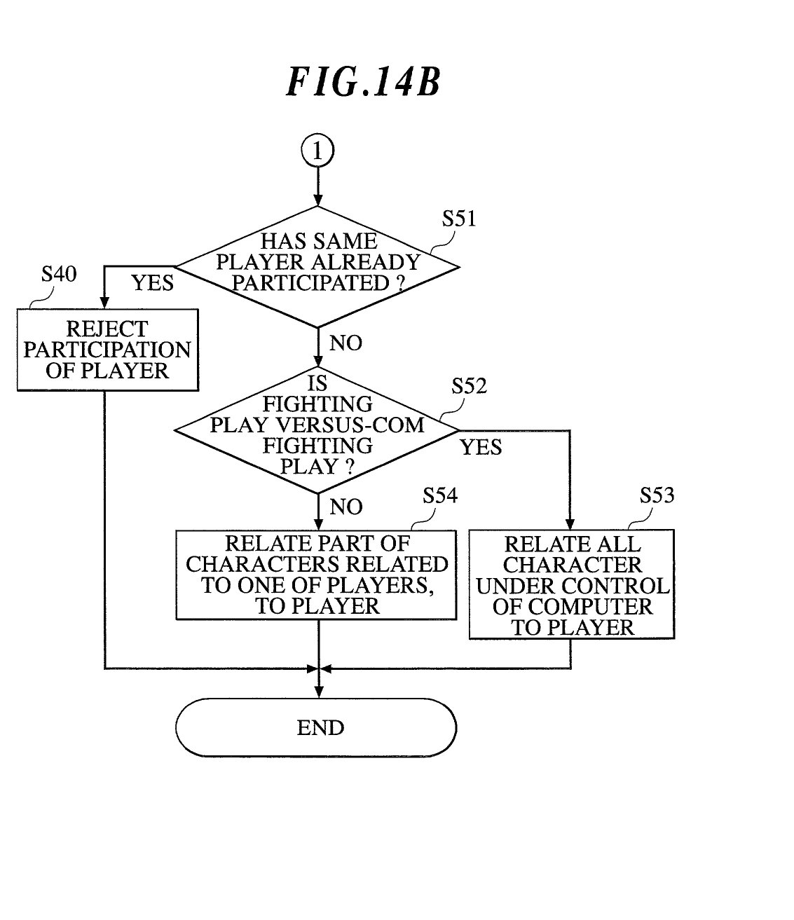

Next, the processing of accepting the participation and the processing of deciding the permit for the participation, which are read out and executed by the game operation unit 210, will be explained with reference to FIGS. 13 to 14B, as follows.

FIG. 13 is a flow chart showing the operation by the processing of accepting the participation, and shows the whole flow of accepting the participation.

In FIG. 13, first, the operating unit discrimination unit 216 of the game operation unit 210 discriminates the input operating unit 10 connected to the processing unit 20 from a plurality of input operating units. Then, when the game operation unit 210 receives the operation signal from the input operating unit 10 discriminated by the operating unit discrimination unit 216, that is, the operation instruction of the player, the game operation unit 210 selects the character according to the operation signal (Step A1).

Thereafter, the relating unit 212 of the game operation unit 210 relates the character selected at the step A1 to the player operating the input operation unit 10, and renews the relating data 252 (Step A2).

Thereafter, the game operation unit 210 decides whether there is some character unrelated to any player or not (Step A3).

When the game operation unit 210 decides that there is not any character unrelated to any player, that is, all character is related to any player (Step A3; NO), the game operation unit 210 finishes the processing of accepting the participation. On the other hand, when the game operation unit 210 decides that there is some character unrelated to any player, that is, all character is not related to any player (Step A3, YES), the game operation unit 210 decides whether the start of the fighting play has been instructed through the input operating unit 10 (Step A4).

When the game operation unit 210 decides that the start of the fighting play hasn't been instructed (Step A4; NO), the game operation unit 210 transfers the process from the step A4 to the step A1.

On the other hand, when the game operation unit 210 decides that the start of the fighting play has been instructed (Step A4; YES), the relating unit 212 relates the character unrelated to any player, to some player (Step A5). Thereafter, the game operation unit 210 finishes the processing of accepting the participation. The process at the step A5 is like the process described with reference to FIGS. 7A to 8B.

FIGS. 14A and 14B are flow charts showing the operation by the processing of deciding the permit for the participation.

The processing of deciding the permit for the participation is carried out as an interrupt processing, when the game operation unit 210 receives the operation signal of applying for the participation in the game, from the input operating unit 10.

In FIG. 14A, first, the participation acceptance unit 214 of the game operation unit 210 decides whether or not the number of the players present playing the game is less than the maximum number of the players, that is, whether or not the number of the players present playing the game is within the number of the players allowable to play the game, with reference to the relating data 252 and the permit condition data 254 (Step S10).

When the participation acceptance unit 214 decides that the number of the present players is not less than the maximum number of the players, that is, that the number of the present players exceeds the number of the allowable players, by permitting the player to participate in the game (Step S10; NO), the participation acceptance unit 214 rejects the participation of the player in the game (Step S 40). Thereafter, the participation acceptance unit 214 finishes the processing of deciding the permit for the participation.

On the other hand, when the participation acceptance unit 214 decides that the number of the present players is less than the maximum number of the players, that is, that the number of the present players is within the number of the allowable players (Step S10; YES), the participation acceptance unit 214 decides whether or not it is before the start of the fighting play (Step S20).

At the step S20, when the participation acceptance unit 214 decides that it is before the start of the fighting play (Step S20; YES), the participation acceptance unit 214 decides whether or not the same player as the player applying for the participation in the game has already participated in the game (Step S31).

At the step S31, when the participation acceptance unit 214 decides that the same player hasn't participated in the game (Step S31; NO), the participation acceptance unit 214 transfers the process from the step S31 to the step S32, to execute the processing of accepting the participation (Step S32). Thereafter, the participation acceptance unit 214 finishes the processing deciding the permit for the participation.

At the step S32, in the case wherein a plurality of characters are related to one of the players, as described with reference to FIGS. 6A and 6B, when the need arises, the participation acceptance unit 214 transfers the process to the step S32, to execute the processing of accepting the participation, after releasing the relationship between the characters and the player.

On the other hand, at the step S31, when the participation acceptance unit 214 decides that the same player has already participated in the game (Step S31; YES), the participation acceptance unit 214 decides whether or not the player desiring to participate in the game can participate in the game with reference to the relating data 252 and the permit condition data 254 (Step 33).

More specifically, according to the state of the permit condition data 254 shown in FIG. 12B, when the player 1P applies for the participation in the game, the player 1P can participate in the game in consideration of the number of players. However, according to the state of the relating data 252 shown in FIG. 12A, because the characters A-1 and A-2 of the group A are related to the player 1P, the participation acceptance unit 214 decides that the player 1P can not participate in the game.

At the step S33, when the participation acceptance unit 214 decides that the player desiring to participate in the game cannot participate in the game (Step S33; NO), the participation acceptance unit 214 rejects the participation of the player in the game (Step S40). Thereafter, the participation acceptance unit 214 finishes the processing of deciding the permit for the participation.

On the other hand, at the step S33, when the participation acceptance unit 214 decides that the player desiring to participate in the game can participate in the game (Step S33; YES), the participation acceptance unit 214 transfers the process to the step S34, to execute the processing of accepting the participation (Step S34). Thereafter, the participation acceptance unit 214 finishes the processing of deciding the permit of the participation.

At the step S20, when the participation acceptance unit 214 decides that it is not before the start of the fighting play, that is, it is during the fighting play (Step S20; NO), the participation acceptance unit 214 transfers the process from the step S20 to the step S51 in FIG. 14B, as following the arrow 1.

In FIG. 14B, the participation acceptance unit 214 decides whether or not the same player as the player applying for the participation in the game has already participated in the game (Step S51).

When the participation acceptance unit 214 decides that the same player has already participated in the game (Step S51; YES), the participation acceptance unit 214 rejects the participation of the player in the game (Step S40). Thereafter, the participation acceptance unit 214 finishes the processing of deciding the permit for the participation.

On the other hand, when the participation acceptance unit 214 decides that the same player hasn't participated in the game (Step S51; NO), the participation acceptance unit 214 decides whether or not the fighting play is the character controlled by the player versus the character controlled by the computer (Step S52). Hereinafter, the fighting play wherein the character under the control of player fights with the character under the control of computer will be referred to as a versus-COM fighting play.

When the participation acceptance unit 214 decides that the fighting play is the versus-COM fighting play (Step S52; YES), the participation acceptance unit 214 relates all character under the control of the computer, to the player applying for the participation in the game (Step S53), as described with reference to FIGS. 10A and 10B. Thereafter, the participation acceptance unit 214 finishes the processing of deciding the permit of the participation.

On the other hand, when the participation acceptance unit 214 decides that the fighting play is not the versus-COM fighting play (Step S52; NO), the participation acceptance unit 214 relates a part of the plurality of characters related to one of the players, to the player applying for the participation in the game (Step S54), as described with reference to FIGS. 9A and 9B. Thereafter, the participation acceptance unit 214 finishes the processing of deciding the permit of the participation.

The processing of deciding the permit for the participation has been explained as one processing, regardless of the start of the fighting play, according to the embodiment of the present invention. However, the processing of deciding the permit for the participation may be divided into the processing at the steps S31 to S40 and the processing at the steps S40 to S54.

Further, when the participation acceptance unit 214 rejects the participation of the player in the game, the participation acceptance unit 214 may give a notice to the player desiring to participate in the game, for example, by generating a beep, by displaying a message representative of the rejection on the display unit 30, or the like.

Furthermore, when the participation acceptance unit 214 permits the player to participate in the game, the participation acceptance unit 214 may interrupt the processing of deciding the permit for the participation temporally, and display a message representative of the permit or display any one of the screens of accepting the participation before the start of the fighting game, as shown in FIGS. 3 to 8B.

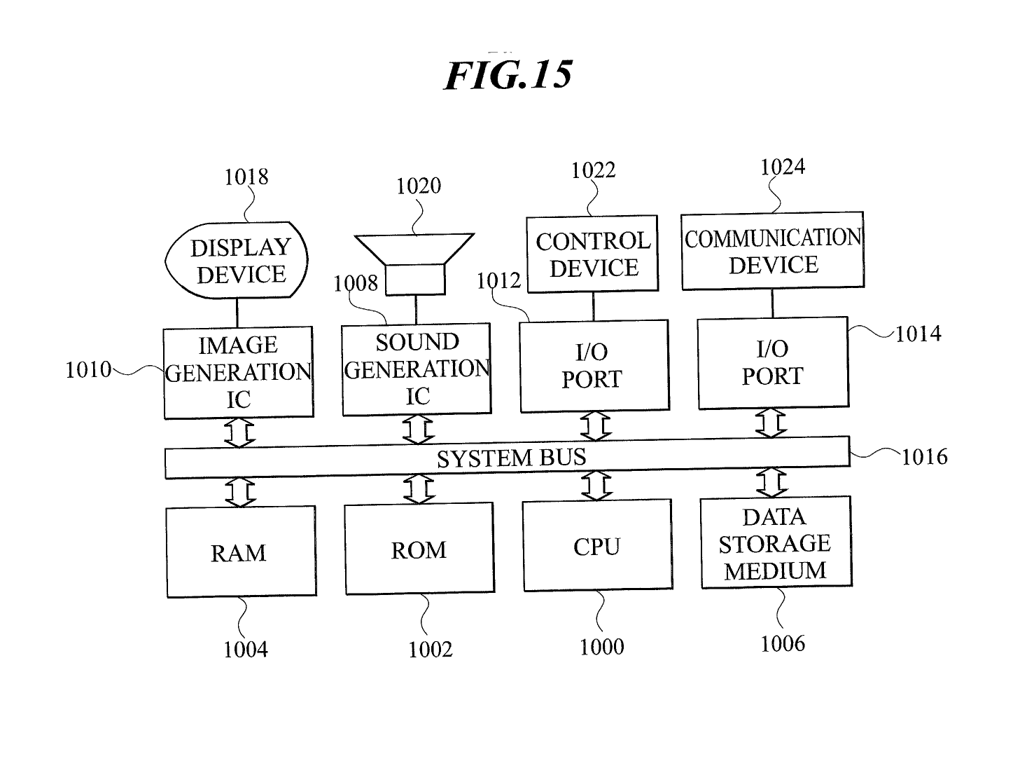

Next, an exemplary hardware configuration realizable the game apparatus according to the embodiment of the present invention will be explained with reference to FIG. 15, as follows.

The game apparatus as shown in FIG. 15 comprises a CPU 1000, a ROM 1002, a RAM 1004, a data storage medium 1006, a sound generation IC 1008, an image generation IC 1010, and I/O ports 1012 and 1014, which are interconnected by a system bus 1016 so that data can be exchanged therebetween. A display devices 1018 is further connected to the image generation IC 1010, a speaker 1020 is further connected to the sound generation IC 1008, a control device 1022 is further connected to the I/O port 1012, and a communication device 1024 is further connected to the I/O port 1014.

The data storage medium 1006 stores primarily a software program, image data for expressing displayed objects, sound data, play data and so on. According to a consumer game machine, for example, a CD-ROM, a game cartridge, a DVD, or other medium is typically used as the data storage medium for storing the game program and other data, and a memory card or other medium is used as the data storage medium for storing the playing data. According to an arcade game machine, a semiconductor memory device such as a ROM or other medium or a hard disk is used as the data storage medium, in which case the data storage medium 1006 can be achieved in the ROM 1002.

The control device 1022 is equivalent to the game controller, the operating panel, or other such device. Further, the control device 1022 is one used by the user to input the results of the decisions received while playing the game to the apparatus body. Furthermore, the control device 1022 corresponds to the game controllers 1201 to 1204 in FIG. 1.

The CPU 1000 controls the overall of the game apparatus and processes various data according to the game program stored to the data storage medium 1006, the operating system (including initialization data for the game apparatus, and so on) stored to the ROM 1002, signals inputted by the control device 1022, and so on.

The RAM 1004 is a storage means used as an operating memory by the CPU 1000, and corresponds to the temporary storage unit 250 in FIG. 11. Further, the RAM 1004 stores not only the relating data 252 and the permit condition data 254 but also particular contents from the data storage medium 1006 or the ROM 1002, operating results from the CPU 1000, and so on.

The sound generation IC 1008 and the image generation IC 1010 are also disposed in this type of game apparatus to generate and output sounds and images appropriate to the game.

The sound generation IC 1008 is an integrated circuit for generating game sounds such as sound effects, background music and so on, based on the data stored to the data storage medium 1006 or the ROM 1002. The game sounds generated by the sound generation IC 10008 are outputted from the speaker 1020.

The image generation IC 1010 is an integrated circuit for generating pixel data to be outputted to the display device 1018, based on the image data received, for example, from the RAM 1004, the ROM 1002, the data storage medium 1006, or the like.

The display device 1018 means a display device such as a CRT, a LCD, a TV, a plasma display, a projector or the like.

The communication device 1024 is for communicating various data used by the game apparatus with an external device. If the game apparatus is connected with another game apparatus, the communication device 1024 handles communicating data with the other game apparatus. The communication device 1024 could also be used to communicate game programs and data with other devices via a communications line.

Various types of processing such as a processing of executing the game, a processing of accepting the participation, a processing of deciding the permit for the participation, and so on are achieved by the data storage medium 1006 which stores the game program 42 and so on, and the CPU 1000, the image generation IC 1010, the sound generation IC 1008 and so on which operates according to the program.

It should be noted that the processes accomplished by the image generation IC 1010, the sound generation IC 1008, and so on, can be written as software applications run by the CPU 1000, a general purpose DSP, or other such device.

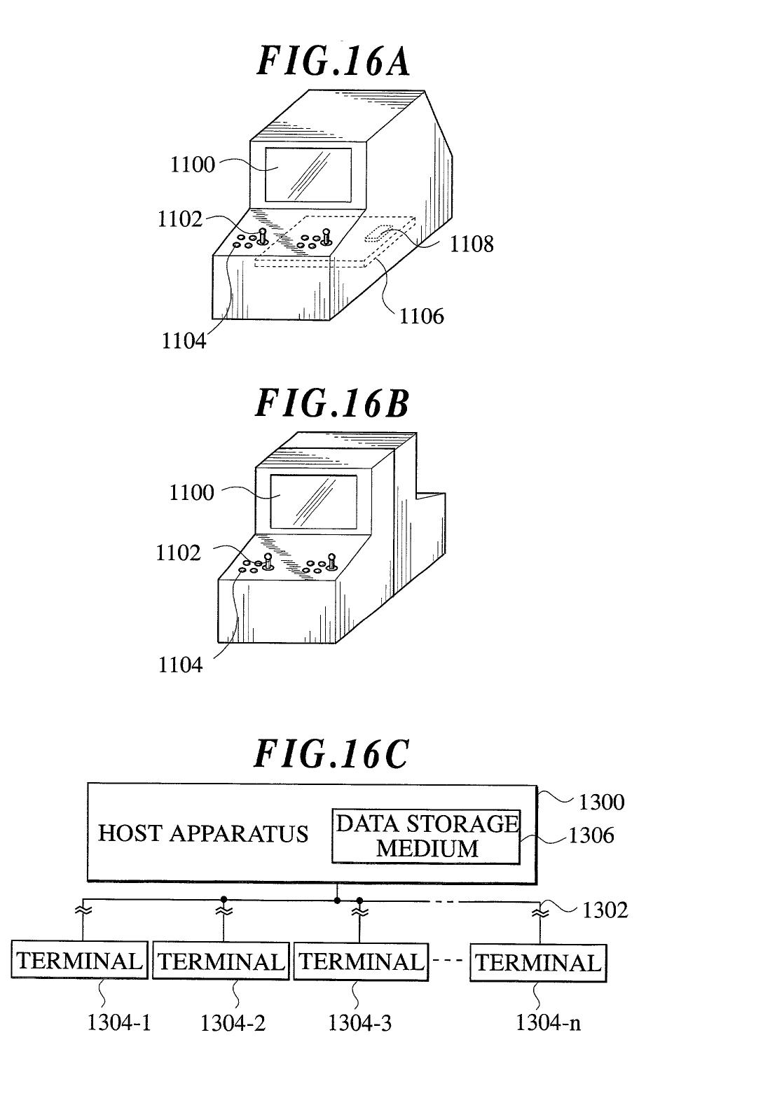

FIGS. 16A and 16B shows exemplary cases wherein the game apparatus of the present invention is applied to an arcade game machine.

The player operates a lever 1102, buttons 1104 and so on, as watching the game image displayed on the display 1100, to enjoy the game. Accordingly, one pair of the lever 1102 and the buttons 1104 are corresponded to one player.

As shown in FIG. 16A, the arcade game machine may be composed of two pairs of the levers and the buttons so that the maximum two players can play the game at the same time.

Further, the arcade game machine may be composed of four pairs of the levers and the buttons so that the maximum four players can play the game at the same time. Furthermore, as shown in FIG. 16B, the arcade game system may be composed of two arcade game machines as shown in FIG. 16A, which are connected to back to back, so that the maximum four players can play the game at the same time. Herein, the construction of connecting a plurality of the game machines to each other is not limited to one as shown in FIG. 16B.

According to the arcade game machine as shown in FIG. 16A, various types of processors, memories and so on are mounted on a system board 1106 that is a circuit board contained in the arcade game machine. The data including programs, for executing each members of the present invention is stored in a memory 1108 that is a data storage medium mounted on the system board 1106. Hereinafter, the data will be referred to as a storage data, as follows.

Further, according to the arcade game system composed of a plurality of arcade game machines connected to each other, as shown in FIG. 16B, any one of the arcade game machines may be worked as a host or a server and remaining game machines may be worked as terminals or clients, so as to be worked as the system as shown in FIG. 16C.

FIG. 16C shows an exemplary case wherein the game apparatus of the present invention is applied to a game system comprising a host apparatus 1300 and terminals 130-1 to 1304-n connected to the host apparatus 1300 through a network 1302. The network 1302 includes a small area network system such as a LAN and a wide area network system such as an Internet.

According to the game system shown in FIG. 16C, the storage data is stored to a data storage medium 1306 under control of the host apparatus 1300, such as a magnetic disk device, a magnetic tape device, a memory, or the like.

In the case wherein each of the terminals 1304-1 to 1304-n can generate game images and game sounds with standing alone, the host apparatus 1300 sends the game program and so on for generating the game images and the game sounds, to each of the terminals 1304-1 to 1304-n. On the other hand, in the case wherein each of the terminals 1304-1 to 1304-n cannot generate game images and game sounds with standing alone, the host apparatus 1300 generates game images and game sounds, to send them to each of terminals 1304-1 to 1304-n. Therefore, each terminal outputs the images and the game sounds.

Although the case wherein the game apparatus of the present invention is applied to a consumer game machine will be explained with reference to FIGS. 1 to 14B, in the case wherein the game apparatus is applied to an arcade game machine as described above, each of the terminals 1304-1 to 1304-n as shown in FIG. 16C corresponds to the player, that is, the input operating unit or the game controller. In other words, the player participates in the game by using any one of the terminals 1304-1 to 1304-n instead of the input operating unit or game controller.

Accordingly, the host apparatus 1300 fundamentally carries out the processing of accepting the participation and the processing of deciding the permit for the participation, and sends the processing results to each of the terminals 1304-1 to 1304-n.

According to the game system having the construction as shown in FIG. 16C, each means of the present invention may be distributed between the host apparatus and each terminal, that is, between the server and the client.

Further, the storage data for executing each means of the present invention may be distributed between the data storage medium of the host apparatus and the data storage medium of each terminal, that is, between the data storage medium of the server and the data storage medium of the client.

Further, according to the game system having the construction as shown in FIG. 16C, one or each of terminals 1304-1 to 1304-n connected to the network 1302 may be the consumer game machine as shown in FIG. 1 or the arcade game machine as shown in FIG. 16A or 16B.

Furthermore, the arcade game machine may be worked as the host apparatus 1300, and the consumer game machine may be worked as one of terminals 1304-1 to 1304-n. In the case, the fighting play may be carried out between the arcade game machine and the consumer game machine.

Furthermore, the arcade game machine worked as the host apparatus 1300 and the consumer game machine worked as one of terminals 1304-1 to 1304-n, may be composed so as to use a portable data storage device such as a memory or a portable game machine, for transferring the data from and to both the arcade game machine and the consumer game machine.

Although the present invention has been explained according to the above-described embodiment, it should also be understood that the present invention is not limited to the embodiment and various changes and modifications may be made to the invention without departing from the gist thereof.

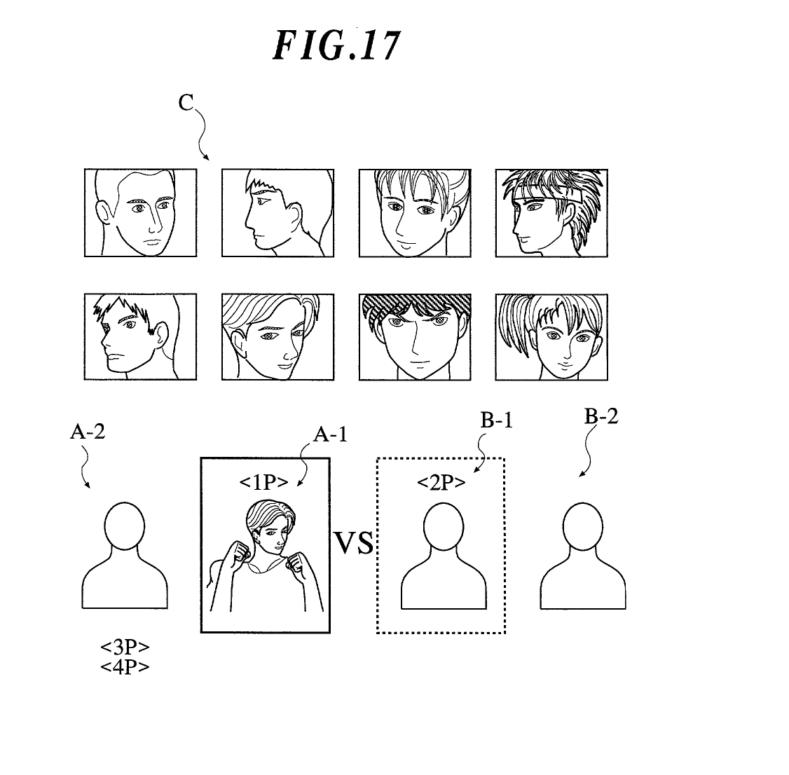

For example, although it has been explained that four characters are fixed as operation objects according to the above-described embodiment, the characters may be able to be selected by the player as shown in FIG. 17. That is, the player may select a favorite character as the operation object from a plurality of characters of a candidate character group C.

As shown in FIG. 17, the character A-1 is designated as the operation object, and given shape selected from the candidate character group C, by the player 1P. Although the character B-1 is temporarily designated as the operation object, by the player 2P, it has not been given shape selected from the candidate character group C, by the player 2P. The characters A-2 and B-2 are not designated as the operation objects by any player. The player 3P and the player 4P are thinking which characters they designate as the operation objects.

Accordingly, because the candidate characters are provided, it is possible that the player selects the favorite character as the operation object from the candidate characters.

Further, although it has been explained that the number of characters is equal to four, the number may be equal to or more than five.

Furthermore, although the fighting play has been explained as the tag play, the fighting play may be applied to team play such judo or kendo.

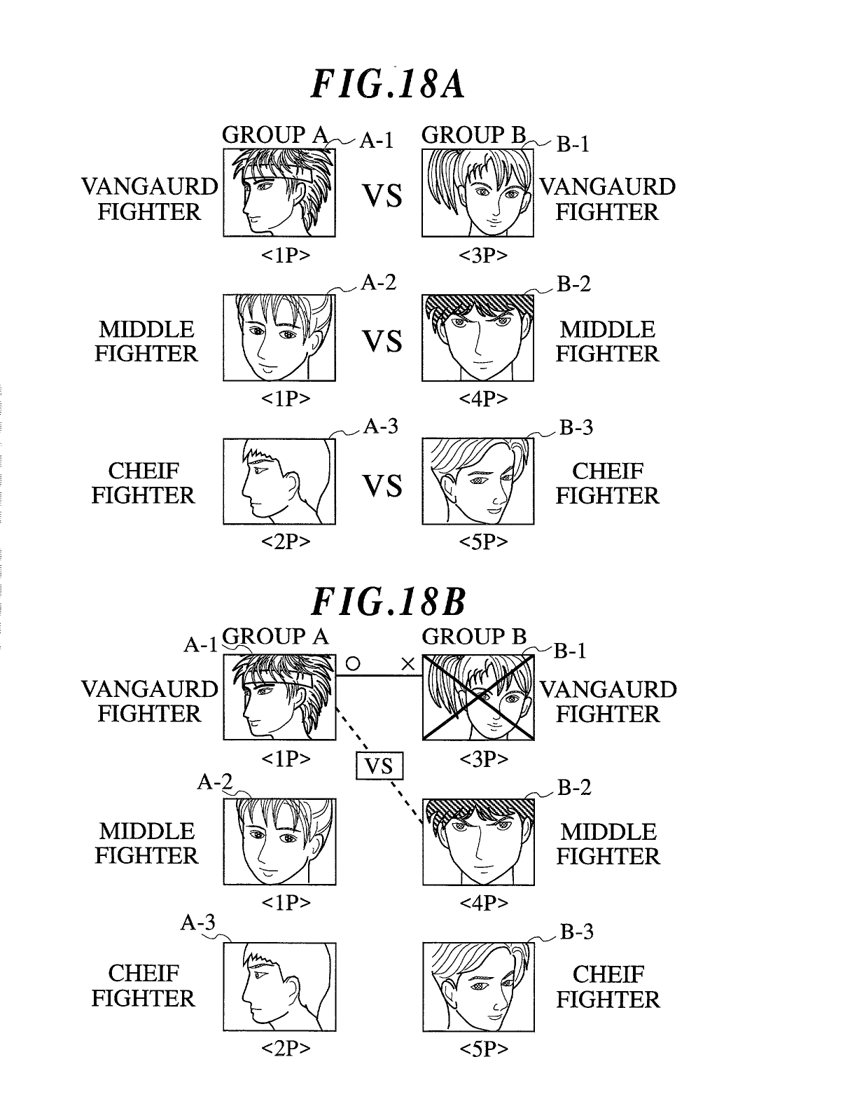

FIGS. 18A and 18B show exemplary cases of the team play in which the number of characters is “six”.

As shown in FIGS. 18A and 18B, the characters A-1 to A-3 belong to the group A. The characters B-1 to B-3 belong to the group B. The characters A-1 and A-2, the character A-3, the character B-1, the character B-2, and the character B-3 are related to the player 1P, the player 2P, the player 3P, the player 4P, and the player 5P, so as to be operated by the player 1P, the player 2P, the player 3P, the player 4P, and the player 5P, respectively.

As shown in FIG. 18A, the characters A-1 fights with the character B-1, as vanguard fighters. The characters A2 fights with the character B-2, as middle fighters. The characters A-3 fights with the character B-3, as chief fighters. As a result, the team having more victories wins the team play.

According to the team play as shown in FIG. 18A, the vanguard fighter, the middle fighter, and the chief fighter of the group A fight with the vanguard fighter, the middle fighter, and the chief fighter of the group B, respectively.

However, for example, according to the team play as shown in FIG. 18B, the vanguard fighter having defeated the opponent vanguard fighter may fight with the opponent middle fighter. That is, the character having defeated the opponent character may fight with the next opponent character (player). More particular, when the character A1 of the group A defeats the character B-1 of the group B, the character A-1 fights with the character B-2 of the group B to which the character B-1 belongs. As a result, the team having the chief fighter having been defeated to any fighter loses the team play.

According to the team play as described above, although the element of the tag play, which is the rotation of the characters has gone, the element of the team play, which is the fight as the representative of the belonging group becomes stronger. Consequently, it is possible that the player gets enjoyment different from one of the tag play.

Further, as shown in FIGS. 18A and 18B, when the number of players is equal to or more than five, the relationship between the player and the character becomes very complex and diversifies. However, the base of the complex relationship has been explained according to the above-described embodiment and will be reached without departing from the gist of the present invention, so that it is omitted to explain the base.

Furthermore, according to the above-described embodiment, it has been explained that the number of characters is fixed and the player exceeding the number cannot participate in the game. However, when some player applies for the participation in the game, the new character may be related to the player, to permit the player to participate in the game.

Furthermore, according to the above-described embodiment, it has been explained as an example, that the present invention has been applied to the fighting action game. However, for example, it is possible that the present invention is applied to another game such as a shooting game or the like.

A main effect according to the embodiment of the present invention will be indicated, as follows.

According to the present invention, it is possible to variously relate characters to players, respectively, in the team play for deciding the winning group on the basis of wins or loses of characters. As a result, it is possible that the user enjoys the more exciting game requiring the teamwork of the player.

The entire disclosure of Japanese Patent Application No. Tokugan 2000-92485 filed on Mar. 29, 2000 including specification, claims, drawings and summary are incorporated herein by reference in its entirety.

What is claimed is:

1. A game apparatus for executing a predetermined game wherein groups each of which is composed of a plurality of characters which are controlled by a player or a computer fight with one another, to decide which group wins the predetermined game in accordance with wins or loses of characters of the groups, the game apparatus comprising:
a selecting section for selecting at least one character to be operated by a player, from the characters; and
a relating section for relating the player to at least one character selected by the selecting section;
wherein a plurality of characters belonging to one of the groups are able to be operated by a plurality of players, respectively.

2. A game apparatus as claimed in claim 1, further comprising:
a permitting section for permitting a player applying for a participation in the predetermined game while the predetermined game is executed, to participate in the predetermined game, when a number of players present participating in the predetermined game is less than a maximum number of players allowable to participate in the predetermined game.

3. A game apparatus as claimed in claim 1, further comprising:
a permitting section for permitting a player applying for a participation in the predetermined game while the predetermined game is executed, to participate in the predetermined game, when a plurality of characters are related to one of the players,
wherein the relating section relates the player permitted for the participation in the predetermined game by the permitting section, to a part of the plurality of characters.

4. A game apparatus as claimed in claim 1, further comprising:
an adding section for adding a new character to one of the groups each of which is composed of a plurality of characters, when a player applies for a participation in the predetermined game while the predetermined game is executed,
wherein the relating section relates the player applying for the participation in the predetermined game to the new character added by the adding section.

5. A game apparatus as claimed in claim 1,
wherein the predetermined game is a fighting action game in which the character belonging to one of the groups is changed to another character belonging to the group at a predetermined time, to fight with the character belonging to one another of the groups.

6. A game apparatus as claimed in claim 1,
wherein the predetermined game is a team game in which the characters belonging to one of the groups fight with the characters belonging to one another of the groups, respectively, in order.

7. A game apparatus comprising:
a selecting section for selecting a plurality of characters belonging to a group, to be operated by a first player;
a relating section for relating a second player to a part of the characters selected by the selecting section, to be operated by the first player, when a number of the characters selected by the selecting section is equal to a number of all the characters belonging to the group; and
a executing section for executing a predetermined game according to a relationship between the characters and the first and second players, related by the relating section.

8. A storage medium having a computer-executable program recorded thereon, wherein the program comprises:
a program code of executing a predetermined game wherein groups each of which is composed of a plurality of characters which are controlled by a player or a computer fight with one another, to decide which group wins the predetermined game in accordance with wins or loses of characters of the groups;
a program code of selecting at least one character to be operated by a player, from the characters; and
a program code of relating the player to at least one character selected to be operated by the player so that a plurality of characters belonging to one of the groups are able to be operated by a plurality of players, respectively.

9. A storage medium having a computer-executable program recorded thereon, as claimed in claim 8, wherein the program further comprises:
a program code of permitting a player applying for a participation in the predetermined game while the predetermined game is executed, to participate in the predetermined game, when a number of players present participating in the predetermined game is less than a maximum number of players allowable to participate in the predetermined game.

10. A storage medium having a computer-executable program recorded thereon, as claimed in claim 8, wherein the program further comprises:
a program code of permitting a player applying for a participation in the predetermined game while the predetermined game is executed, to participate in the predetermined game, when a plurality of characters are related to one of the players; and
a program code of relating the player permitted for the participation in the predetermined game to a part of the plurality of characters.

11. A storage medium having a computer-executable program recorded thereon, as claimed in claim 8, wherein the program further comprises:
a program code of adding a new character to one of the groups each of which is composed of a plurality of characters, when a player applies for a participation in the predetermined game while the predetermined game is executed; and
a program code of relating the player applying for the participation in the predetermined game to the new character.

12. A storage medium having a computer-executable program recorded thereon, wherein the program comprises:
a program code of selecting a plurality of characters belonging to a group, to be operated by a first player;
a program code of relating a second player to a part of the characters selected to be operated by the first player, when a number of the characters selected to be operated by the first player is equal to a number of all the characters belonging to the group; and
a program code of executing a predetermined game by displaying a game image according to a relationship between the characters and the first and second players.

13. A transmission medium transmitting a computer-executable program embodied thereon, wherein the program comprises:
a program code of executing a predetermined game wherein groups each of which is composed of a plurality of characters which are controlled by a player or a computer fight with one another, to decide which group wins the predetermined game in accordance with wins or loses of characters of the groups;
a program code of selecting at least one character to be operated by a player, from the characters; and
a program code of relating the player to at least one character selected to be operated by the player so that a plurality of characters belonging to one of the groups are able to be operated by a plurality of players, respectively.

14. A transmission medium transmitting a computer-executable program embodied thereon, between a host apparatus and a plurality of game terminals in a game system, wherein the program comprises:
a program code of executing a predetermined game wherein groups each of which is composed of a plurality of characters which are controlled by a player or a computer fight with one another, to decide which group wins the predetermined game in accordance with wins or loses of characters of the groups, in the game system; and
a program code of relating the game terminal to at least one character so that a plurality of characters belonging to one of the groups are able to be operated by a plurality of game apparatuses, respectively.

15. A transmission medium transmitting a computer-executable program embodied thereon, as claimed in claim 14, wherein the program further comprises:
a program code of permitting the game apparatus applying for a participation in the predetermined game while the predetermined game is executed, to participate in the predetermined game, when a number of players present participating in the predetermined game is less than a maximum number of players allowable to participate in the predetermined game.

16. A transmission medium transmitting a computer-executable program embodied thereon, as claimed in claim 14, wherein the program further comprises:
a program code of permitting the game apparatus applying for a participation in the predetermined game while the predetermined game is executed, to participate in the predetermined game, when a plurality of characters are related to one of the game apparatuses; and
a program code of relating the game apparatus permitted for the participation in the predetermined game to a part of the plurality of characters.

17. A transmission medium transmitting a computer-executable program embodied thereon, as claimed in claim 14, wherein the program further comprises:
a program code of adding a new character to one of the groups each of which is composed of a plurality of characters, when the game apparatus applies for a participation in the predetermined game while the predetermined game is executed; and
a program code of relating the game apparatus applying for the participation in the predetermined game to the new character.

18. A computer program comprising program code means for performing the steps of:
executing a predetermined game wherein groups each of which is composed of a plurality of characters which are controlled by a player or a computer fight with one another, to decide which group wins the predetermined game in accordance with wins or loses of characters of the groups;
selecting at least one character to be operated by a player, from the characters; and
relating the player to at least one character selected to be operated by the player.

19. A computer program as claimed in claim 18, further comprising program code means for performing the step of:
permitting a player applying for a participation in the predetermined game while the predetermined game is executed, to participate in the predetermined game, when a number of players present participating in the predetermined game is less than a maximum number of players allowable to participate in the predetermined game.

20. A computer program as claimed in claim 18, further comprising program code means for performing the steps of:
permitting a player applying for a participation in the predetermined game while the predetermined game is executed, to participate in the predetermined game, when a plurality of characters are related to one of the players; and
relating the player permitted for the participation in the predetermined game to a part of the plurality of characters.

21. A computer program as claimed in claim 18, further comprising program code means for performing the steps of:
adding a new character to one of the groups, when a player applies for a participation in the predetermined game while the predetermined game is executed; and
relating the player applying for the participation in the predetermined game to the new character.

22. A game apparatus comprising;
an executing section for executing a predetermined game wherein groups each of which is composed of a plurality of characters fight with one another, to decide which group wins the predetermined game in accordance with wins or loses of the characters of the groups;
an operating section for selecting at least one character from the characters to operate at least one character selected thereby; and
a relating section for relating the operating section to at least one character selected by the operating section.
